(19) United States
(12) Patent Application Publication
(10) Pub. No.: US 2019/0042011 A1
(43) Pub. Date: Feb. 7, 2019

(54) TOUCH PANEL AND MANUFACTURING METHOD THEREOF

(71) Applicants: BOE TECHNOLOGY GROUP CO., LTD., Beijing (CN); HEFEI XINSHENG OPTOELECTRONICS TECHNOLOGY CO., LTD., Anhui (CN)

(72) Inventors: Chenglong PAN, Beijing (CN); Peihuan NING, Beijing (CN); Guangchao WEI, Beijing (CN); Min HE, Beijing (CN); Liantao WANG, Beijing (CN); Longlong WANG, Beijing (CN); Yu CHEN, Beijing (CN)

(73) Assignees: BOE TECHNOLOGY GROUP CO., LTD., Beijing (CN); HEFEI XINSHENG OPTOELECTRONICS TECHNOLOGY CO., LTD., Anhui (CN)

(21) Appl. No.: 15/951,609

(22) Filed: Apr. 12, 2018

(30) Foreign Application Priority Data
Aug. 1, 2017 (CN) 201710646161.1

(51) Int. Cl. G06F 3/041

(52) U.S. Cl. CPC G06F 3/041; G06F 2203/04103

(57) ABSTRACT

A manufacturing method includes steps of: providing a substrate having a first side and a second side opposite to the first side; forming a first protection layer at the first side of the substrate to cover a plurality of touch units; forming a second protection layer on the first protection layer and at the second side of the substrate; cutting the substrate into a plurality of secondary substrates; subjecting an edge of each secondary substrate to treatment; removing the second protection layer at a second side of each secondary substrate; applying a first coating onto the second side of the secondary substrate; forming a third protection layer onto the first coating; removing the second protection layer at a first side of each secondary substrate; and forming a fourth protection layer on the first protection layer at the first side of each secondary substrate.

### CROSS-REFERENCE TO RELATED APPLICATION

This application claims priority to Chinese Patent Application No. 201710646161.1 filed on Aug. 1, 2017, which is incorporated herein by reference in its entirety.

### TECHNICAL FIELD

The present disclosure relates to the field of display technology, in particular to a touch panel and a manufacturing method thereof.

### BACKGROUND

As a product for man-machine interaction, a touch panel has been widely used in production and life, especially in consumer electronics (e.g., mobile phones, flat-panel computers or televisions).

The touch panel mainly includes a resistive touch panel, a capacitive touch panel, an infrared touch panel and a surface acoustic wave touch panel. The capacitive touch panel has currently become a mainstream product in the market due to such advantages as high response sensitivity, being capable of supporting multi-point touch and long service life. For a new-generation One Glass Solution (OGS) technique, a touch sensor is directly formed on a protection glass substrate. In this way, one glass substrate is capable of achieving a protection function and a touch sensing function simultaneously.

### SUMMARY

In one aspect, the present disclosure provides in some embodiments a method for manufacturing a touch panel, including steps of: providing a substrate, the substrate having a first side and a second side opposite to the first side, a plurality of touch units being arranged at the first side of the substrate, each touch unit including a touch structure and a wiring structure surrounding the touch structure; forming a first protection layer at the first side of the substrate, to cover the plurality of touch units; forming a second protection layer on the first protection layer and at the second side of the substrate; cutting the substrate into a plurality of secondary substrates, each secondary substrate including one of the touch units; subjecting an edge of each secondary substrate to treatment; removing the second protection layer at a second side of each secondary substrate; applying a first coating onto the second side of the secondary substrate; forming a third protection layer onto the first coating; removing the second protection layer at a first side of each secondary substrate; and forming a fourth protection layer on the first protection layer at the first side of each secondary substrate.

In a possible embodiment of the present disclosure, in the case of removing the second protection layer at the second side of each secondary substrate, the method further includes removing the second protection layer arranged at the first side of each secondary substrate and covering the wiring structure, and reserving the second protection layer covering the touch structure.

In a possible embodiment of the present disclosure, subsequent to the step of forming the first protection layer and prior to the step of removing the second protection layer at the first side of each secondary substrate, the method further includes removing a portion of the first protection layer to expose a bonding region of the wiring structure.

In a possible embodiment of the present disclosure, subsequent to the step of forming the third protection layer and prior to removing the second protection layer at the first side of each secondary substrate, the method further includes bonding an Integrated Circuit (IC) chip to the bonding region of the wiring structure.

In a possible embodiment of the present disclosure, the step of subjecting the edge of each secondary substrate to treatment includes grinding, polishing and reinforcing the edge of each secondary substrate.

In a possible embodiment of the present disclosure, the first protection layer is an insulation protection layer, the second protection layer is a peelable adhesive layer, the third protection layer is an intermediate process film, the fourth protection layer is an explosion-proof film, and the first coating is a fingerprint-proof coating.

In a possible embodiment of the present disclosure, the insulation protection layer is made of at least one of propylene glycol monomethyl ether acetate (PGMEA), acrylic-based resin, polymethyl methacrylate (PMMA) and diethylene glycol methyl ethyl ether (DEGMEE).

In a possible embodiment of the present disclosure, the intermediate process film is made of polyethylene glycol terephthalate (PET).

In a possible embodiment of the present disclosure, the explosion-proof film includes one or more of a glass film, a sapphire film and a PET film.

In a possible embodiment of the present disclosure, the method further includes removing the third protection layer.

In a possible embodiment of the present disclosure, the touch structure includes an indium tin oxide (ITO) pattern electrode.

In a possible embodiment of the present disclosure, the step of forming the second protection layer on the first protection layer and at the second side of the substrate includes forming a peelable adhesive layer on the first protection layer and at the second side of the substrate through silk-screen printing.

In another aspect, the present disclosure provides in some embodiments a touch panel, including: a substrate having a first side and a second side opposite to the first side; a plurality of touch units arranged at the first side of the substrate and each including a touch structure and a wiring structure surrounding the touch structure; a first protection layer covering and being in contact with the touch units; a first coating covering and being in contact with the second side of the substrate; and a fourth protection layer covering and being in contact with the first protection layer.

In a possible embodiment of the present disclosure, the touch panel further includes a third protection layer covering and being in contact with the first coating.

In a possible embodiment of the present disclosure, the wiring structure has a bonding region.

In a possible embodiment of the present disclosure, the touch panel further includes an IC chip bonded to the bonding region of the wiring structure.

In a possible embodiment of the present disclosure, the first protection layer is an insulation protection layer, the second protection layer is a peelable adhesive layer, the third protection layer is an intermediate process film, the fourth protection layer is an explosion-proof film, and the first coating is a fingerprint-proof coating.

In a possible embodiment of the present disclosure, the insulation protection layer is made of at least one of PGMEA, acrylic-based resin, PMMA and DEGMEE.

In a possible embodiment of the present disclosure, the intermediate process film is made of PET.

In a possible embodiment of the present disclosure, the touch structure includes an (ITO pattern electrode.

According to the embodiments of the present disclosure, the first protection layer, e.g., the insulation protection layer, is formed at the first side of the substrate to protect the touch structure and the wiring structure. In this way, in the case that the fourth protection layer, e.g., the explosion-proof film, is attached onto the insulation protection layer, it is able to prevent the occurrence of bubbles. In addition, it is able to simplify the manufacture process of the touch panel and reduce the manufacture cost thereof.

The aspects and scopes of the present disclosure will become more apparent through the description. It should be appreciated that, each aspect may be implemented individually or in combination with one or more other aspects. It should be further appreciated that, the description and the embodiments of the present disclosure are for illustrative purposes only, but shall not be used to limit the scope of the present disclosure.

### BRIEF DESCRIPTION OF THE DRAWINGS

The following drawings are used to merely illustrate some embodiments of the present disclosure, but shall not be used to reflect all possible embodiments or limit the scope of the present disclosure.

FIG. 1A is a top view of an intermediate structure of a touch panel;

FIG. 1B is a top view of the touch panel;

FIG. 1C is a sectional view of the touch panel in FIG. 1B along line A-A;

FIG. 2 is a flow chart of a method for manufacturing a touch panel according to one embodiment of the present disclosure;

FIG. 3A is a top view of an intermediate structure of the touch panel according to one embodiment of the present disclosure;

FIG. 3B is a top view of the touch panel according to one embodiment of the present disclosure; and

FIG. 3C is a sectional view of the touch panel in FIG. 3B along line A-A.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

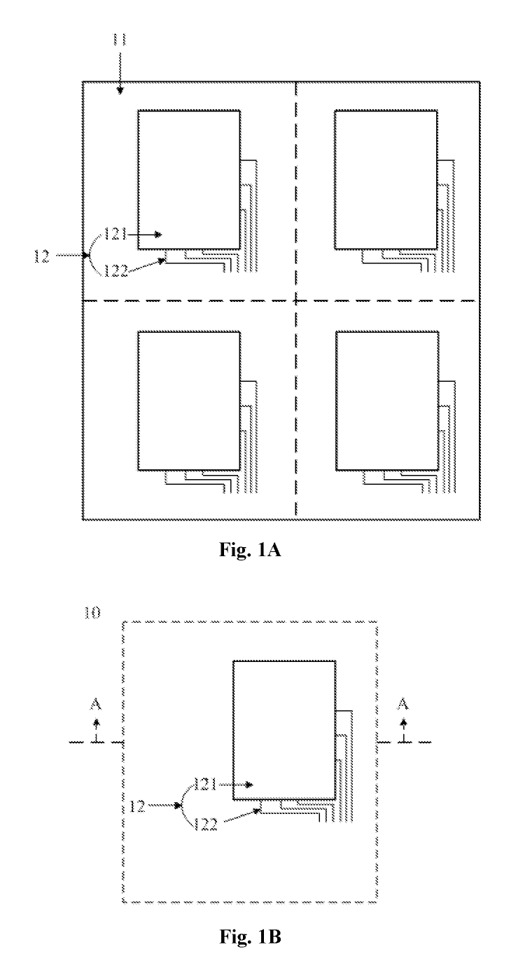

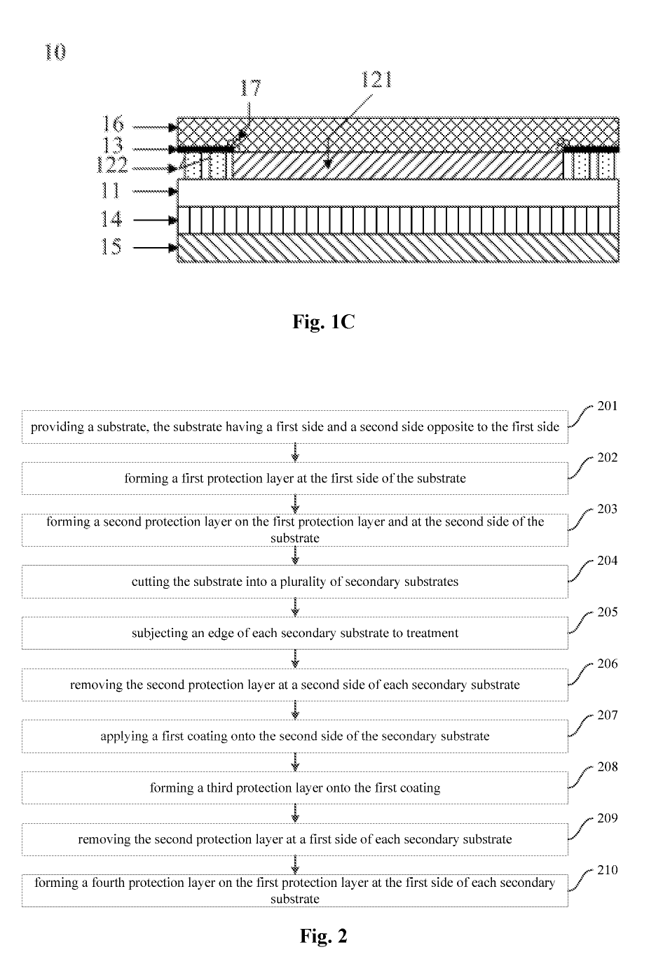

FIG. 1A is a top view of an intermediate structure of a touch panel 10, FIG. 1B is a top view of the touch panel 10, and FIG. 1C is a sectional view of the touch panel 10 in FIG. 1B along line A-A. A structure of the touch panel 10 and a manufacturing method thereof will be described hereinafter with reference to FIGS. 1A to 1C. The manufacturing method includes the following steps.

Step S101: providing a substrate 11. The substrate 11 has a first side and a second side opposite to the first side. A plurality of (e.g., four) touch units 12 is arranged at the first side of the substrate 11, and each touch unit 12 includes a touch structure 121 and a wiring structure 122 surrounding the touch structure 121. A light-shielding structure is further arranged at the first side of the substrate 11 and surrounds each touch structure 121, so as to prevent the occurrence of light leakage at an edge of the substrate 11. The light-shielding structure may be arranged at a layer identical to the touch structure 121, and the wiring structure 122 may be arranged on the light-shielding structure.

Step S102: forming a peelable adhesive layer on the touch structure 121 and the wiring structure 122 as well as at the second side of the substrate 11 through, e.g., silk-screen printing.

Step S103: cutting the substrate 11 into a plurality of (e.g., four) secondary substrates. Each secondary substrate includes one touch unit 12.

Step S104: grinding, polishing and reinforcing an edge of each secondary substrate.

Step S105: removing, e.g., peeling off, the peelable adhesive layer at a third side of each secondary substrate corresponding to the second side and the peelable adhesive layer arranged at a fourth side of each secondary substrate corresponding to the first side and covering the wiring structure 122.

Step S106: forming a thermosetting ink layer or an ultraviolet (UV)-curable ink layer 13 on the wiring structure 122 through, e.g., silk-screen printing, to protect the wiring structure 122.

Step S107: forming a fingerprint-proof coating 14 at the third side of each secondary substrate through, e.g., coating.

Step S108: forming, e.g., attaching, an intermediate process film 15 on the fingerprint-proof coating 14.

Step S109: removing, e.g., peeling off, the peelable adhesive layer arranged at the fourth side of each secondary substrate and covering the touch structure 121, and attaching an intermediate process film onto the touch structure 121.

Step S110: bonding, e.g., hot-pressing, an IC chip to a bonding region of the wiring structure 122.

Step S111: removing, e.g., peeling off, the intermediate process film arranged at the fourth side of each secondary substrate and covering the touch structure 121, and attaching an explosion-proof film 16 onto the thermosetting ink layer or the UV-curable ink layer 13 as well as the touch structure 121.

The touch panel 10 may be manufactured through the above-mentioned steps. Due to the thermosetting ink layer or UV-curable ink layer 13 on the wiring structure 122, there is a gradient between the thermosetting ink layer or the UV-curable ink layer 13 and the touch structure 121 in a longitudinal direction of the cross section in the drawings (i.e., the vertical direction in the drawings). In the case of attaching the explosion-proof film 16, bubbles 17 may easily occur at a position where the gradient is located.

In order to solve the above-mentioned problem, the present disclosure provides in some embodiments a method for manufacturing a touch panel. According to the method in the embodiments of the present disclosure, a first protection layer, e.g., an insulation protection layer, is formed at a first side of a substrate, to protect a touch structure and a wiring structure. It is unnecessary to provide the additional ink layer to protect the wiring structure in the case of forming the fingerprint-proof layer, so it is able to prevent the occurrence of the gradient, and thereby prevent the occurrence of the bubbles in the case of attaching the explosion-proof film onto the insulation protection layer. In addition, in the case that the insulation protection layer is used to protect the touch units, it is able to omit the step of forming the intermediate processing film on the touch units before the bonding of the IC chip, so as to simplify the manufacture process of the touch panel and reduce the manufacture cost thereof.

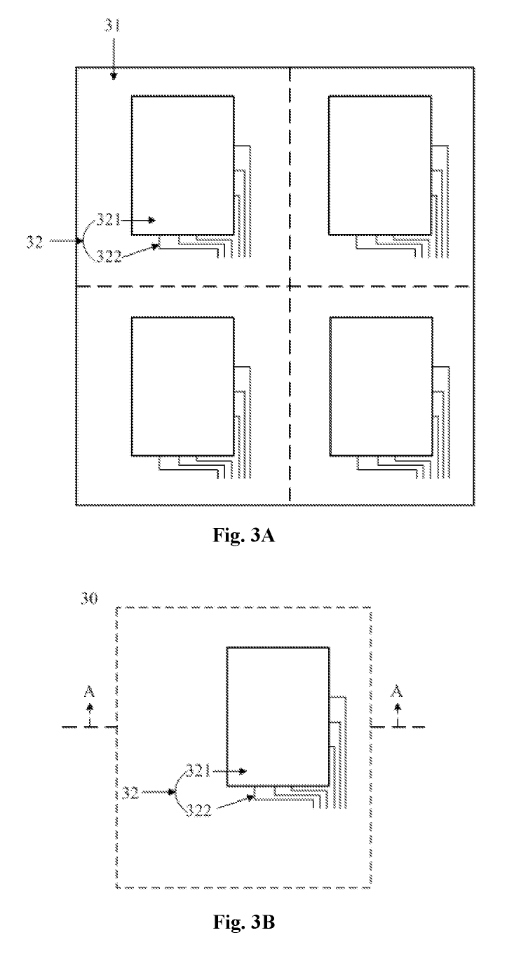

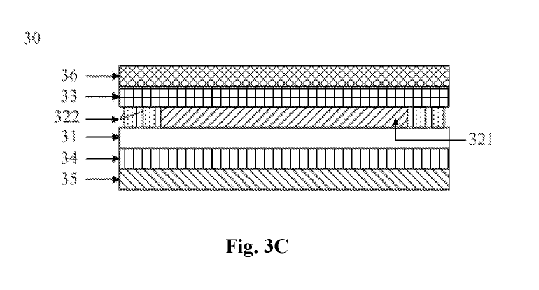

A method for manufacturing a touch panel 30 and a structure of the touch panel 30 will be described hereinafter with reference to FIGS. 2 and 3A-3C. FIG. 2 is a flow chart of the method for manufacturing the touch panel, FIG. 3A is a top view of an intermediate structure of the touch panel 30 manufactured using the method in FIG. 2, FIG. 3B is a top view of the touch panel 30, and FIG. 3C is a sectional view of the touch panel 30 in FIG. 3B along line A-A. As shown in FIGS. 2 and 3A-3C, the method includes: S201 of providing a substrate, the substrate having a first side and a second side opposite to the first side, a plurality of touch units being arranged at the first side of the substrate, each touch unit including a touch structure and a wiring structure surrounding the touch structure; S202 of forming a first protection layer at the first side of the substrate to cover the plurality of touch units; S203 of forming a second protection layer on the first protection layer and at the second side of the substrate; S204 of cutting the substrate into a plurality of secondary substrates, each secondary substrate including one of the touch units; S205 of subjecting an edge of each secondary substrate to treatment; S206 of removing the second protection layer at a second side of each secondary substrate; S207 of applying a first coating onto the second side of the secondary substrate; S208 of forming a third protection layer onto the first coating; S209 of removing the second protection layer at a first side of each secondary substrate; and S210 of forming a fourth protection layer on the first protection layer at the first side of each secondary substrate.

In Step 201, as shown in FIG. 3A, the substrate 31 is provided, and it has the first side and the second side arranged opposite to the first side. Four touch units 32 are arranged at the first side of the substrate 31, and each touch unit 32 includes the touch structure 321 and the wiring structure 322 surrounding the touch structure 321. The touch structure 321 may include an ITO pattern electrode. It should be appreciated that, the pattern electrode may also be made of any other transparent conductive material. The ITO pattern electrode may be formed as follows. At first, an ITO film is formed at the first side of the substrate 31 through magnetron sputtering, and then a desired ITO pattern may be formed through etching using a photolithography process. The photolithography process includes a sputtering process, a layer coating process, an exposure process, a development process, a film hardening process, a film removing process and an etching process, which are known in the art and thus will not be particularly defined herein. The wiring structure 322 may include a metal wiring electrode connected to the ITO pattern electrode of the touch structure 321, so as to deliver a signal and perform a touch operation.

It should be appreciated, the situation where four touch units 32 are arranged at the first side of the substrate 31 in FIG. 3A is merely for illustrative purposes, and the number of the touch units 32 may be set in accordance with the practical need.

In addition, a light-shielding structure may also be arranged at the first side of the substrate 31 and surround the touch structure 321, to prevent the occurrence of the light leakage at the edge of the substrate 31. The light-shielding structure may be formed on the substrate 31 through, e.g., silk-screen printing. In a possible embodiment of the present disclosure, the light-shielding structure may be arranged at a layer identical to the touch structure 321, and the wiring structure 322 may be arranged on the light-shielding structure.

In S202, as shown in FIG. 3C, the first protection layer 33 is formed at the first side of the substrate 31 (i.e., an upper side of the substrate 31 in FIG. 3C). The first protection layer 33 covers the touch structure 321 and the wiring structure 322 of each touch unit 32. The protection layer 33 has high light transmittance and insulativity, and it is capable of preventing the touch structure 321 from being scratched and preventing the wiring structure 322 from being oxidized and falling off from the substrate in the case of being heated. In addition, the first protection layer 33 may further have an anti-static capability. In a possible embodiment of the present disclosure, the first protection layer 33 may be an insulation protection layer such as an overcoat (OC), and it may be formed at the first side of the substrate 31 through evaporation. The insulation protection layer may be made of, but not limited to, at least of PGMEA, acrylic-based resin, PMMA and DEGMEE.

In S203, the second protection layer (which will be removed subsequently) is formed on the first protection layer 33 and at the second side of the substrate 31 (i.e., a lower side of the substrate 31 in FIG. 3C). Through the second protection layer, it is able to prevent the first protection layer 33 and the substrate 31 from being scratched or polluted subsequently. In a possible embodiment of the present disclosure, the second protection layer may be a peelable adhesive layer formed on the first protection layer 33 and at the second side of the substrate 31 through, e.g., silk-screen printing.

In S204, the substrate 31 is cut into four secondary substrates, and each secondary substrate includes one touch unit 32.

In S205, the edge of each secondary substrate is subjected to treatment. For example, the edge of each secondary substrate may be ground in a computerized numerical control (CNC) manner using a diamond cutting wheel or sintered cutting wheel, and then fine-ground using a brush, so as to polish and reinforce the edge of each secondary substrate.

In S206, the second protection layer at the second side of each secondary substrate is removed. In this step, in order to further simplify the manufacture process, the second protection arranged at the first side of each secondary substrate and covering the wiring structure 322 may be removed simultaneously, and the second protection layer covering the touch structure 321 may be reserved. The second protection layer may be removed physically. It should be appreciated that, the removal of the second protection layer arranged at the first side of each secondary substrate and covering the wiring structure 322 may also be performed subsequently.

In S207, as shown in FIG. 3C, the first coating 34 is formed at the second side of each secondary substrate. In a possible embodiment of the present disclosure, the first coating 34 may be a fingerprint-proof layer, so as to prevent the occurrence of fingerprints or any other contaminants thereon. The fingerprint-proof coating may be formed at the second side of each secondary substrate through coating.

In S208, as shown in FIG. 3C, the third protection layer 35 is formed on the first coating 34. Through the third protection layer 35, it is able to prevent the first coating 34 from being polluted or scratched. In a possible embodiment of the present disclosure, the third protection layer 35 may be an intermediate process film formed on the first coating 34 through, e.g., attachment. The intermediate process film may be made of PET, and it may be removed before the use of the touch panel 30.

In S209, the second protection layer arranged at the first side of each secondary substrate and covering the touch structure 321 is removed, e.g., physically.

In S210, as shown in FIG. 3C, the fourth protection layer 36 is formed at the first side of each secondary substrate, i.e., on the first protection layer 33. In a possible embodiment of the present disclosure, the fourth protection layer 36 may be an explosion-proof film, to prevent the touch panel 30 from being damaged after collision. The fourth protection layer 36 may be formed at the first side of each secondary substrate through, e.g., attachment, and it may include one of a glass film (e.g., a tempered glass film), a sapphire film and a PET film.

As mentioned above, the first protection layer (e.g., the insulation protection layer) covers the touch structure and the wiring structure of each touch unit, so it is able to prevent the occurrence of bubbles in the case of forming the fourth protection layer (e.g., the explosion-proof film) on the first protection layer. In addition, due to the first protection layer, it is unnecessary to provide an additional ink layer to protect the wiring structure, and provide an additional intermediate process fill to protect the touch structure, thereby to simplify the manufacture process of the touch panel and reduce the manufacture cost thereof.

Subsequent to the formation of the first protection layer 33 (i.e., S202) and prior to the removal of the second protection layer at the first side of each secondary substrate (i.e., S209), e.g., subsequent to S202, the method may further include removing a portion of the first protection layer 33 to expose a bonding region of the wiring structure 322. The bonding region may be located at a position adjacent a corner of the substrate 31. It should be appreciated that, the bonding region may also be arranged at any other position, as long as the IC chip is capable of being electrically connected to the bonding region of the wiring structure. It should be further appreciated that, the portion of the first protection layer 33 at any other desired portion may also be removed in accordance with the practical need, e.g., the portion of the first protection layer 33 may be removed to expose a function hole (e.g., a hole where a camera is to be installed) or a logo. In a possible embodiment of the present disclosure, the portion of the first protection layer 33 may be removed through photolithography.

Subsequent to the formation of the third protection layer 35 (i.e., S208) and prior to the removal of the second protection layer at the first side of each secondary substrate (i.e., S209), e.g., immediately prior to S209, the method may further include bonding the IC chip to the bonding region of the wiring structure 322 through, e.g., hot-pressing, to enable the IC chip to be electrically connected to the wiring structure 322.

The present disclosure further provides in some embodiments a touch panel 30 manufactured using the above-mentioned method. As shown in FIGS. 3B and 3C, the touch panel 30 includes a substrate 31, a first protection layer 33, a first coating 34, and a fourth protection layer 36. The substrate 31 has a first side and a second side arranged opposite to the first side. A plurality of touch units 32 is arranged at the first side of the substrate 31, and each touch unit 32 includes a touch structure 321 and a wiring structure 322 surrounding the touch structure 321. The first protection layer 33 covers, and is in contact with, the touch unit 32. The first coating 34 covers, and is in contact with, the second side of the substrate 31. The fourth protection layer 36 covers, and is in contact with, the first protection layer 33.

In a possible embodiment of the present disclosure, the touch panel 30 further includes a third protection layer 35 covering, and being in contact with, the first coating 34. The wiring structure 322 has a bonding region, and the touch panel 30 further includes an IC chip bonded to the bonding region of the wiring structure 322.

In a possible embodiment of the present disclosure, the first protection layer 33 is an insulation protection layer, the third protection layer 35 is an intermediate process film, the fourth protection layer 36 is an explosion-proof film, and the first coating 34 is a fingerprint-proof coating. The insulation protection layer is made of at least one of PGMEA, acrylic-based resin, PMMA and DEGMEE. The intermediate process film is made of PET.

The above are merely the preferred embodiments of the present disclosure, but the present disclosure is not limited thereto. Obviously, a person skilled in the art may make further modifications and improvements without departing from the spirit of the present disclosure, and these modifications and improvements shall also fall within the scope of the present disclosure.

What is claimed is:

1. A method for manufacturing a touch panel, comprising steps of:
providing a substrate, the substrate having a first side and a second side opposite to the first side, a plurality of touch units being arranged at the first side of the substrate, each touch unit comprising a touch structure and a wiring structure surrounding the touch structure;
forming a first protection layer at the first side of the substrate to cover the plurality of touch units;
forming a second protection layer on the first protection layer and at the second side of the substrate;
cutting the substrate into a plurality of secondary substrates, each secondary substrate comprising one of the touch units;
subjecting an edge of each secondary substrate to treatment;
removing the second protection layer at a second side of each secondary substrate;
applying a first coating onto the second side of the secondary substrate;
forming a third protection layer onto the first coating;
removing the second protection layer at a first side of each secondary substrate; and
forming a fourth protection layer on the first protection layer at the first side of each secondary substrate.

2. The method according to claim 1, wherein in the case of removing the second protection layer at the second side of each secondary substrate, the method further comprising removing the second protection layer arranged at the first side of each secondary substrate and covering the wiring structure, and reserving the second protection layer covering the touch structure.

3. The method according to claim 1, wherein subsequent to the step of forming the first protection layer and prior to the step of removing the second protection layer at the first side of each secondary substrate, the method further comprises removing a portion of the first protection layer to expose a bonding region of the wiring structure.

4. The method according to claim 3, wherein subsequent to the step of forming the third protection layer and prior to removing the second protection layer at the first side of each secondary substrate, the method further comprises bonding an Integrated Circuit (IC) chip to the bonding region of the wiring structure.

5. The method according to claim 1, wherein the step of subjecting the edge of each secondary substrate to treatment comprises grinding, polishing and reinforcing the edge of each secondary substrate.

6. The method according to claim 1, wherein the first protection layer is an insulation protection layer, the second protection layer is a peelable adhesive layer, the third protection layer is an intermediate process film, the fourth protection layer is an explosion-proof film, and the first coating is a fingerprint-proof coating.

7. The method according to claim 6, wherein the insulation protection layer is made of at least one of propylene glycol monomethyl ether acetate (PGMEA), acrylic-based resin, polymethyl methacrylate (PMMA) and diethylene glycol methyl ethyl ether (DEGMEE).

8. The method according to claim 6, wherein the intermediate process film is made of polyethylene glycol terephthalate (PET).

9. The method according to claim 6, wherein the explosion-proof film comprises one or more of a glass film, a sapphire film and a PET film.

10. The method according to claim 1, further comprising removing the third protection layer.

11. The method according to claim 1, wherein the touch structure comprises an indium tin oxide (ITO) pattern electrode.

12. The method according to claim 1, wherein the step of forming the second protection layer on the first protection layer and at the second side of the substrate comprises forming a peelable adhesive layer on the first protection layer and at the second side of the substrate through silk-screen printing.

13. A touch panel, comprising:
a substrate having a first side and a second side opposite to the first side;
a plurality of touch units arranged at the first side of the substrate and each comprising a touch structure and a wiring structure surrounding the touch structure;
a first protection layer covering and being in contact with the touch units;
a first coating covering and being in contact with the second side of the substrate; and
a fourth protection layer covering and being in contact with the first protection layer.

14. The touch panel according to claim 13, further comprising a third protection layer covering and being in contact with the first coating.

15. The touch panel according to claim 13, wherein the wiring structure has a bonding region.

16. The touch panel according to claim 15, further comprising an Integrated Circuit (IC) chip bonded to the bonding region of the wiring structure.

17. The touch panel according to claim 14, wherein the first protection layer is an insulation protection layer, the third protection layer is an intermediate process film, the fourth protection layer is an explosion-proof film, and the first coating is a fingerprint-proof coating.

18. The touch panel according to claim 17, wherein the insulation protection layer is made of at least one of propylene glycol monomethyl ether acetate (PGMEA), acrylic-based resin, polymethyl methacrylate (PMMA) and diethylene glycol methyl ethyl ether (DEGMEE).

19. The touch panel according to claim 17, wherein the intermediate process film is made of polyethylene glycol terephthalate (PET).

20. The touch panel according to claim 13, wherein the touch structure comprises an indium tin oxide (ITO) pattern electrode.
